(19) United States
(12) Patent Application Publication
(10) Pub. No.: US 2009/0316801 A1
(43) Pub. Date: Dec. 24, 2009

(54) Radio Device, Electronic Device, and Imaging Device

(75) Inventors: Keiichi Nitta, Kawasaki-shi (JP); Takashi Matsukuma, Kawasaki-shi (JP)

Correspondence Address: OLIFF & BERRIDGE, PLC, P.O. BOX 320850, ALEXANDRIA, VA, 22320-4850, US

(73) Assignee: NIKON CORPORATION, Chiyoda-ku, Tokyo (JP)

(21) Appl. No.: 11/922,240

(22) PCT Filed: Jun. 12, 2006
(86) PCT No.: PCT/JP2006/311757

§ 371 Date: Dec. 14, 2007

(30) Foreign Application Priority Data
Jun. 23, 2005 (JP) 2005-183726

(51) Int. Cl. H04K 1/10

(52) U.S. Cl. 375/260

(57) ABSTRACT

A radio device for transmitting or receiving desired information through an MIMO transmission line, and an electronic device and an imaging device which have the radio device and supplied with drive power together with the radio device may realize to implement a desired radio transmission flexibly in the form suitable for the battery residual amount and power consumption, in which plural antenna sections for performing radio communication by a spatial division multiplexing method on an MIMO transmission line, and a controller for increasing or decreasing the number of the antenna portions used for the radio transmission.

### TECHNICAL FIELD

The present invention relates to a radio device for transmitting or receiving desired information through an MIMO transmission line, and an electronic device and an imaging device each of which is provided with the radio device and supplied with drive power along with the radio device.

### BACKGROUND ART

Recently, IEEE 802.11 task group n has promoted to standardize wireless LAN which can secure compatibility with an existing system implemented through one antenna and also can implement a transmission speed exceeding 100 MHz/second. With respect to MIMO (Multiple Input Multiple Output) which is the core technique of such wireless LAN as described, studies and developments thereon have been also promoted as described in Patent Document 1 described later.

### Patent Document 1: Japanese Unexamined Patent Application Publication No. 2002-191073

### DISCLOSURE OF THE INVENTION

### Problems to be Solved by the Invention

Real-time high-speed processing is generally required to implement radio transmission based on MIMO described above, and thus large power is consumed by hardware. Accordingly, as disclosed in the above Japanese Unexamined Patent Application Publication No. 2002-191073, a power source which can supply large power is required to implement high-speed data communication through plural antennas.

Furthermore, it is particularly difficult to secure such a power source in a compact device. Therefore, effective use of radio transmission based on MIMO is obstructed, or not only a continuously operable time is restricted, but also there may be a probability that transmission or reception of desired transmission information through an MIMO transmission line cannot be performed normally during a period when the power consumed by a device concerned is large. However, a technique of enabling the radio transmission based on MIMO described above has been strongly required in connection with the requirements of enhancing the performance and additive values for even devices as described above.

### Means for Solving the Problems

The present invention has an object to provide a radio device that can flexibly implement desired radio transmission in the form suitable for battery remaining power and power consumption, an electronic device and an imaging device.

An invention according to claim 1 is characterized by including: plural antenna sections for performing radio communication on an MIMO transmission line by a spatial division multiplexing method, and a controller for increasing or decreasing the number of the antenna sections used for the radio communication.

An invention according to claim 2 is characterized by including: plural antenna sections for performing radio communication on an MIMO transmission line by a spatial division multiplexing method; and a controller for decreasing the number of the antenna sections used for the radio communication when it is judged that the antenna sections do not operate normally due to reduction of a voltage supplied from a power supply unit for supplying power to the antenna sections.

An invention according to claim 3 is characterized in that the power supply unit switches power supplied from a battery and power supplied from a commercial power source to each other and supplies the power to the antenna sections, and the controller does not decrease the number of the antenna sections even when the voltage from the battery decreases in the radio device according to claim 2.

An invention according to claim 4 is characterized in that the antenna sections include plural antennas for transmitting and receiving electrical waves and an electrical circuit connected to the antennas in the radio device according to claim 2.

An invention according to claim 5 is characterized in that the controller judges that the antenna sections do not operate normally when the residual amount of the power source is smaller than a predetermined first value, and decreases the number of the antenna sections used for the radio communication in the invention according to claim 2.

An invention according to claim 6 is characterized in that the controller judges that the antenna sections do not operate normally when the residual amount of the power source is smaller than a predetermined second value and a predetermined unit in the radio device is instructed to be driven, and decreases the number of the antenna sections used for the radio communication in the radio device according to claim 2.

An invention according to claim 7 is characterized in that the controller controls to perform substitute radio transmission based on a non-spatial division multiplexing method on a radio transmission line formed by the antenna sections when the number of the antenna sections is decreased by one in the radio device according to any one of claims 1 to 6.

An invention according to claim 8 is characterized in that the controller controls to perform substitute ratio transmission based on a non-spatial division multiplexing method on a radio transmission line formed by the antenna sections and also carry out a diversity operation when the number of the antenna sections is decreased to a number smaller than a predetermined sixth value in the radio device according to any one of claims 1 to 6.

An invention according to claim 9 is characterized in that the controller controls to perform substitute ratio transmission based on a spatial division multiplexing method corresponding to the number of the antenna sections used for the radio communication on a radio transmission line formed by the antenna sections used for the radio communication when the number of the antenna sections is reduced to a number smaller than a predetermined seventh value in the radio device according to any one of claims 1 to 6.

An invention according to claim 10 is characterized in that the controller reduces an amplification degree in the electrical circuit of the antenna section used for the spatial dividing multiplexing method when the residual amount of the power source is smaller than a predetermined first value in the radio device according to claim 4.

An invention according to claim 11 is characterized in that the controller notifies change of the number of the antenna sections to a reception terminal or transmission terminal of the MIMO transmission line before the number of the antenna sections used for the radio communication is changed in the radio device according to any one of claims 1 to 10.

An invention according to claim 12 is characterized by including the radio device according to any one of claims 1 to 11, and a reception information processor for processing information received by the radio device.

An invention according to claim 13 is characterized by including the radio device according to any one of claims 1 to 11, and a transmission information processing unit for processing information transmitted by the radio device.

An invention according to claim 14 is characterized by including an imaging element for picking up an image of a subject and the radio device according to any one of claims 1 to 11.

The construction of a technique related to the present invention of this application will be described.

(1) A radio device to which a first technique related to the present invention is applied is a radio device for transmitting or receiving transmission information on the basis of a spatial division multiplexing method through an MIMO transmission line, and characterized by including a controller for controlling to decrease the number of branches used for transmission or reception on the basis of a judgment that the residual amount of a power supply for supplying driving power is smaller than a predetermined first value.

(2) A radio device to which a second technique related to the present invention is applied is a radio device for transmitting or receiving transmission information based on a spatial division multiplexing system through an MIMO transmission line, and is characterized by including a controller for controlling to decrease the number of branches used for transmission or reception on the basis of a judgment that driving power consumed is larger than a predetermined second value.

(3) A radio device to which a third technique related to the invention is applied is a radio device for transmitting or receiving transmission information on the basis of a spatial division multiplexing method through an MIMO transmission line, and characterized by including a controller for controlling to decrease the number of branches used for transmission or reception on the basis of a judgment that an information amount of transmission information is larger than a predetermined third value.

(4) A radio device to which a fourth technique related to the invention is applied is a radio device for transmitting or receiving transmission information on the basis of a spatial division multiplexing method through an MIMO transmission line, and characterized by including a controller for controlling to decrease the number of branches used for transmission or reception on the basis of a judgment that the speed of transmission or reception of transmission information through an MIMO transmission line is larger than a predetermined fourth value.

(5) Preferably, the control unit sets to decrease the number of branches when it is judged that the distance between the reception terminal and the transmission terminal is shorter than a predetermined fifth value.

(6) Preferably, when the number of set branches is equal to 1, the control unit controls to perform substitute radio transmission different from the spatial division multiplexing method through a radio transmission line formed through the set one branch concerned.

(7) Preferably, when the number of the set branches is lower than a predetermined sixth value, the controller carries out substitute radio transmission different from the spatial division multiplexing method through the branches of the number concerned, and also carries out a diversity operation.

(8) Preferably, when the number of the set branches is lower than a predetermined seventh value, the controller controls to perform substitute radio transmission based on the spatial division multiplexing method through the branches of the number concerned.

(9) Preferably, during a period when the residual amount of a power source for supplying drive power is lower than a predetermined first value, the controller sets the transmission power used for the transmission to a smaller value as the residual amount is smaller.

(10) Preferably, before the number of branches used for transmission or reception is renewed, the controller cooperates with a reception terminal or a transmission terminal through a radio transmission line formed through the branches of the number concerned.

(11) A radio application device to which a fifth technique related to the present invention is applied is characterized by including the radio device according to any one of (1) to (10), plural branches used for transmission or reception by the radio device, and reception processing unit for processing transmission information received through the plural branches and the radio device, or transmission processing unit functioning as an information source of transmission information transmitted by the radio device.

### EFFECT OF THE INVENTION

According to the present invention, radio transmission of desired transmission information is stably maintained in a restricted range of power which can be supplied, and also even a compact device attains high transmission quality and transmission speed and also enhances added values.

### BRIEF DESCRIPTION OF THE DRAWINGS

FIG. 1 is a diagram showing first and second embodiments according to the present invention.

FIG. 2 is a diagram showing the flow of signals (data) between respective units of an imaging device 10 and an external device 40 in the first and second embodiments of the present invention.

FIG. 3 is a flowchart showing the operation of a communication module 30 according to the first embodiment of the present invention.

FIG. 4 is a flowchart showing the operation of a communication module 30E according to the first embodiment of the present invention.

### BEST MODE FOR CARRYING OUT THE INVENTION

Embodiments according to the present invention will be hereunder described with reference to the drawings.

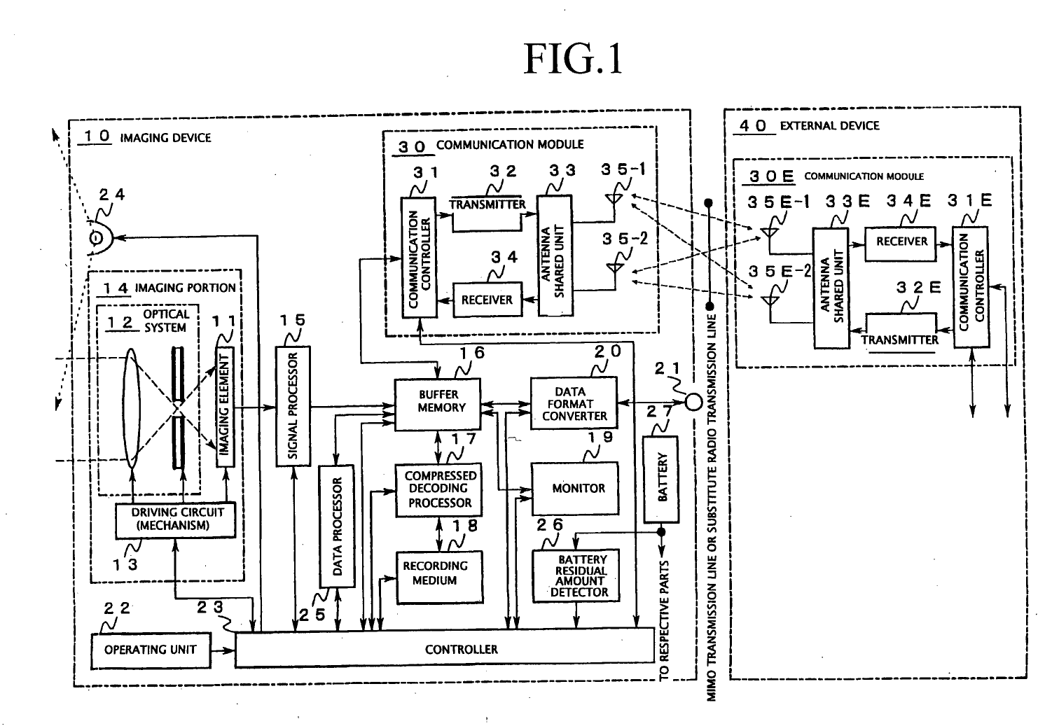

FIG. 1 is a diagram showing first and second embodiments according to the present invention.

In the figure, an imaging device 10 and an external device 40 are disposed so as to be spaced from each other at a predetermined distance.

The imaging device 10 is equipped with an imaging unit 14 including an imaging element 11, an optical system 12 for forming an image of a subject (not shown) on an imaging plane of the imaging element 11, and a driving circuit (mechanism) 13 for driving the imaging element 11 and the optical system 12. The output of the imaging element 111 is connected to a first port of a buffer memory 16 through a signal processor 15. A second port of the buffer memory 16 is connected to a recording medium 18 through a compression decoding processor 17. Third and fourth ports of the buffer memory 16 are connected to a monitor 19 and a data format converter 20, respectively. The output of the data format converter 20 is connected to a connector 21 which is used for connection to a device connected to the external. An operating unit 22 is connected to a first input port of the controller 23. The output port of the controller 23 is connected to a control terminal of an illuminator 24. The first and second input/output ports of the controller 23 are connected to the control terminals of a driving circuit (mechanism) 13 and a signal processor 15. The third input/output port of the controller 23 is connected to the control terminal of a data processor 25, and the input/output terminal of the data processor 25 is connected to a fifth port of the buffer memory 16. The fourth to eight input/output ports of the controller 23 are connected to the corresponding control terminals of the buffer memory 16, the compression decoding processor 17, a recording medium 18, the monitor 19 and the data format converter 20, respectively. The terminal of a battery 27 for supplying driving power to each unit is connected to the input of a battery residual amount detector 26, and the output of the battery residual amount detector 26 is connected to the second input port of the controller 23. The sixth port of the buffer memory 16 and the ninth input/output port of the controller 23 are connected to a communication module 30.

A communication controller 31 is disposed at the first stage in the communication module 30, and the sixth port of the buffer memory 16 and the ninth input/output port of the controller 23 are connected to the communication controller 31. The output of the communication controller 31 is connected to the transmission input of an antenna shared unit 33 through a transmitter 32. The reception output of the antenna shared unit 33 is connected to the input of the communication controller 31 through a receiver 34. Two antenna terminals provided to the antenna shared unit 33 are connected to the respective feeding points of antennas 35-1 and 35-2 disposed so as to be spaced from each other at a predetermined interval.

The transmitter 32 and the receiver 34 are provided with power amplifiers corresponding to the antennas 35-1 and 35-2.

The external device 40 is provided with a communication module 30E having the same construction as the communication module 30 described above. With respect to the communication module 30E as described above, in order to discriminate it from the elements of the communication module 30 provided to the imaging device 10, common reference numerals suffixed with a character “E” are allocated to individual corresponding elements, and the detailed descriptions of the constructions thereof are omitted.

The common operation of first and second embodiments according to the present invention will be described with reference to FIG. 1.

The controller 23 of the imaging device 10 controls the operation of each unit on the basis of an operation carried out through the operating unit 22 by an operator and a default sequence. The imaging unit 14 implements automatic focusing and zooming under the control as described above, and also outputs an image signal obtained by picking up an image of the subject through the imaging element 11. The subject matter as an imaging target is illuminated with flash light or timely-continuous illumination light emitted from an illuminating unit 24 under the control of the controller 23. The signal processor 15 subjects this image signal to signal processing such as DC reproduction, A/D conversion, white balance, gamma conversion, electronic zoom, etc., and accumulates the image data obtained as a signal processing result into the buffer memory 16 having a storage capacity of plural frames. The data processor 25 subjects the image data stored in the buffer memory 16 to operation processing or resolution conversion processing between frames. Thus-processed image data are input to the compression decoding processor 17 through the buffer memory 16 as occasion demands, converted to predetermined data format by a data format converter 20, and then output to a device such as a computer or the like through a connector 21. The compressor decoding processor 17 executes compression processing on the image data which are processed in the data processor 25 as described above as occasion demands, and records the processing result into the recording medium 18 together with attendant data related to the processing result (for example, the accumulation time of the imaging element 11, the compression rate used for the compression processing by the compression decoding processor 17, etc., for example). The compression decoding processor 17 may be designed to decode the image data compressed under the control of the controller 23, and also output the decoded image data corresponding to the compressed image data recorded in the recording medium 18 through the connector 21.

The monitor 19 displays image information obtained as the result of the signal processing described above by the signal processor 15, or the image corresponding to the compressed image data recorded in the recording medium 18, the image corresponding to image data received by the communication controller 31 as described later, a menu for supporting the operation carried out by the operator through the operating unit 22, etc.

### First Embodiment

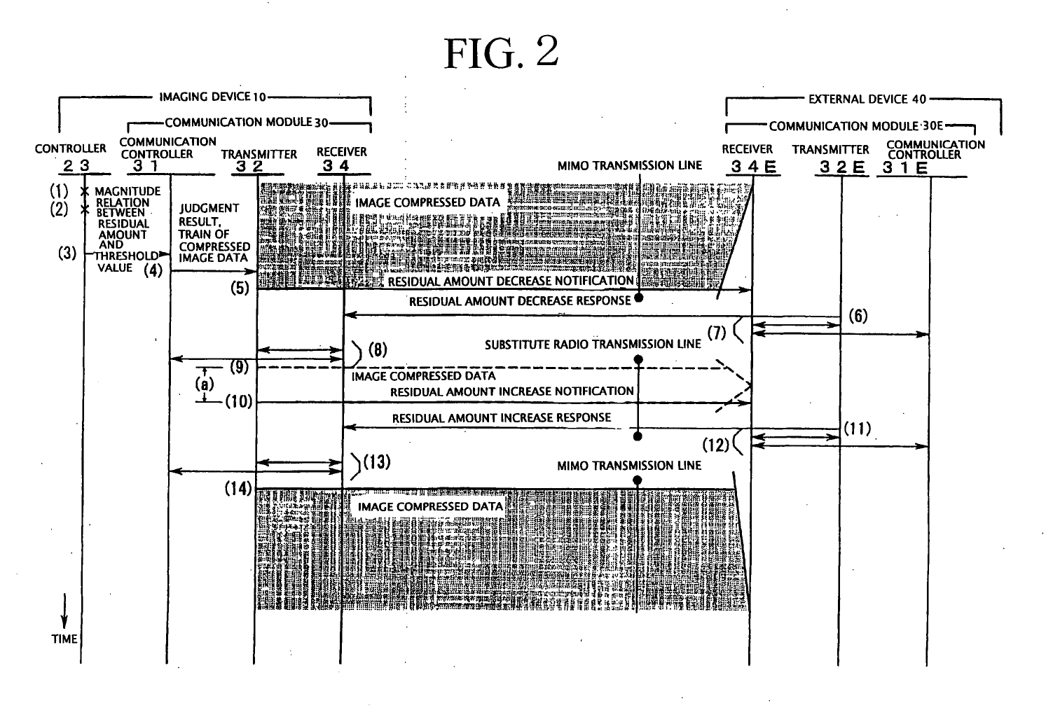

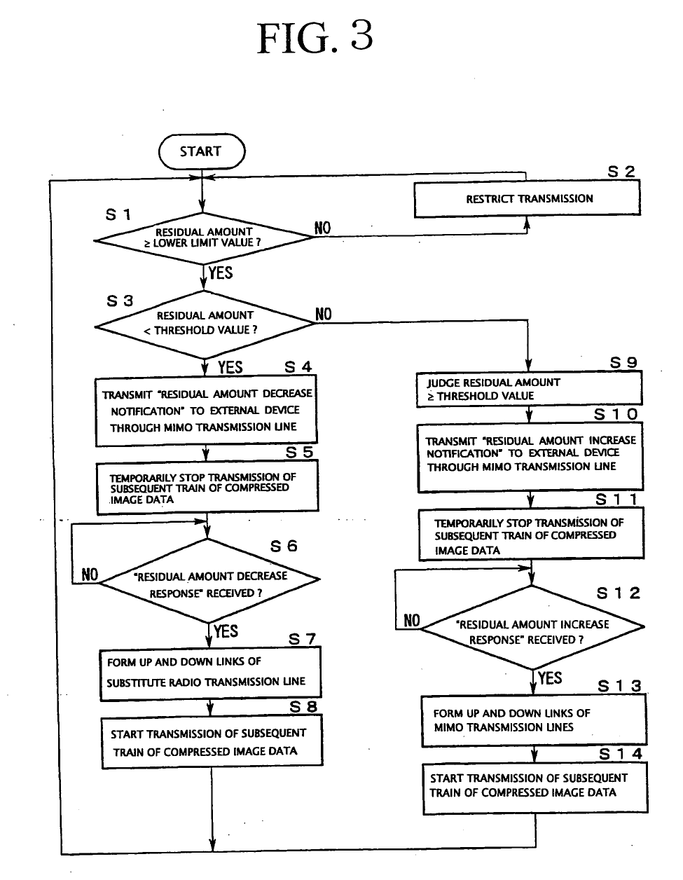

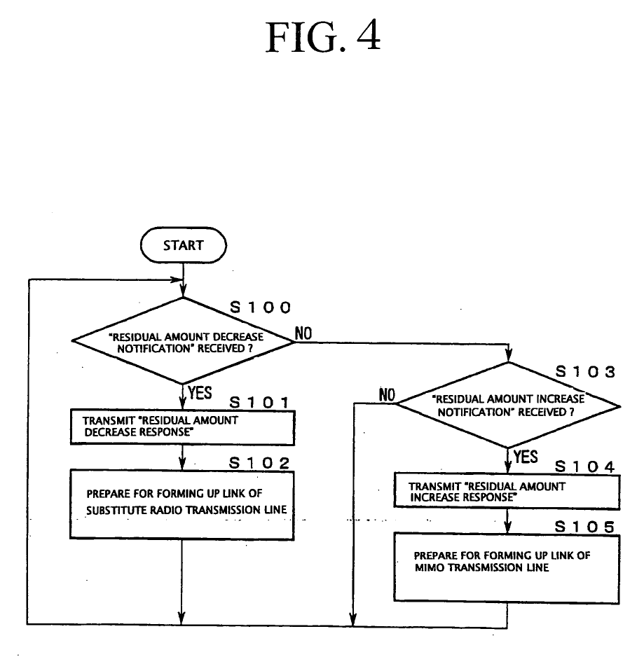

FIG. 2 is a diagram showing the flow of signals (data) between the respective units of the imaging device 10 and the external device 40 according to the first embodiment and the second embodiment described later of the present invention. FIG. 3 is a flowchart showing the operation of the communication module 30 according to the first embodiment of the present invention. FIG. 4 is a flowchart showing the operation of the communication module 30E according to the first embodiment of the present invention. The operation of the first embodiment according to the present invention will be described with reference to FIGS. 1 to 4.

The feature of this embodiment resides in the following operation which is carried out by the communication module 30E provided to the external device 40 in cooperation with the controller 23, the battery residual amount detector 26 and the communication module 30.

The battery residual detector 26 detects the residual amount of the battery 27 under the control of the controller 23. The residual amount of the battery 27 can be calculated on the basis of the voltage of the battery 27, the internal resistance value, etc. When the battery 27 is a battery pack containing a microcomputer, the residual amount of the battery 27 may be detected on the basis of residual amount information transmitted by the microcomputer concerned. The controller 23 compares a default lower limit value (smaller than a threshold value described later) with the detection result (hereinafter referred to as “residual amount”) every predetermined period or frequency (FIG. 2(1), Step S1 of FIG. 3), and when this residual amount is less than the lower limit value, the transmission carried out by the transmitter 32 is stopped through the communication controller 31 (step S2 of FIG. 3), and a display for promoting exchange or charging of the battery 27 is made through the monitor 19. A mark “X” shown in (1), (2) of FIG. 2 represents a point of each processing on the time axis (ordinate axis). On the other hand, when the residual amount is equal to the above lower limit value or more, each unit executes the following series of processing.

The controller 23 judges the magnitude relation between the residual amount described above and a predetermined threshold value (which is given as a limit at which transmission/reception through the MIMO transmission line can be continued) (FIG. 2(2), step S3 of FIG. 3). Furthermore, the controller 23 notifies this judgment result to the communication controller 31 successively or at a predetermined frequency (FIG. 2(3)), and also displays it on the monitor 19 as a message (for example, “an alarm indicating lack of the residual amount of the battery 27”, or “an alarm indicating that radio communication is carried out under the state that transmission performance is restricted”). The communication controller 31 successively outputs the judgment result notified as described above and the sequence of compressed image data recorded in the buffer memory 16 to the transmitter 32 (FIG. 2(4)). The communication module 30 and the communication module 30E provided to the external device 40 operate in cooperation with each other as indicated by the following styles [1] to [4] in accordance with the judgment result of the magnitude relation between the residual amount and the threshold value.

[1] A case where the judgment result is varied because the residual amount of the battery 27 is lowered than the threshold value

In the communication module 30, the transmitter 32 transmits a signal “residual-amount decrease notification” through the MIMO transmission line described above with addressing to the external device 40 (FIG. 2(5), step S4 of FIG. 3), and also temporarily stops transmission of a subsequent train of compressed image data (step S5 of FIG. 3).

In the external device 40, the receiver 34E cooperates with the transmitter 32E through the communication controller 31E when it receives the signal “residual-amount decrease notification” (step S100 of FIG. 4). The transmitter 32E transmits a signal “residual-amount decrease response” meaning reception of the “residual-amount decrease notification” signal to the communication module 30 (imaging device 10) through the rising link of the MIMO transmission line described above (FIG. 2(6), step S101 of FIG. 4). Furthermore, the receiver 34E prepares for forming a radio transmission line (for example, which corresponds to a radio transmission line through any one of the antennas 35E-1, 35E-2 without using the spatial division multiplexing method, and it will be hereunder referred to as “substitute radio transmission line”) replacing the original MIMO transmission line between the receiver 34E and the communication module 30 provided to the imaging device 10 (for example, stop of the supply of drive power to one power amplifier which is not used for formation of the substitute radio transmission line out of the plural power amplifiers corresponding to the respective antennas (35E-1, 35E-2) provided to the transmitter 32E and the receiver 34E, and stop of the operation thereof)(FIG. 2(7), step S102 of FIG. 4). The executing order of the step S101 and the step S102 of FIG. 4 may be inverted. In this case, the “residual-amount decrease response” signal becomes a signal representing that reception preparation for substitute ratio transmission of the reception side (the external device 40) is completed. Or, the step S101 and the step S102 of FIG. 4 may be executed in parallel.

In the communication module 30, when the receiver 34 receives the “residual-amount decrease response” transmitted from the external device 40 (step S6 of FIG. 3), the receiver 34 cooperates with the transmitter 32 through the communication controller 31. The transmitter 32 prepares for forming up and down links of the substitute radio transmission line described above between the transmitter 32 and the communication module 30E provided to the external device 40 (for example, stop of supply of drive power to one power amplifier which is not used for formation of the substitute radio transmission line out of the plural power amplifiers corresponding to the antennas (35-1, 35-2) provided to the transmitter 32 and the receiver 34, and stop of the operation thereof) (FIG. 2(8), step S7 of FIG. 3). Furthermore, when the preparation as described above is completed, the transmitter 32 starts to transmit a subsequent train of compressed image data to the communication module 30E (external device 40) through the substitute radio transmission line while addressing to the communication module 30E (FIG. 2(9), step S8 of FIG. 3).

[2] When the residual amount of the battery 27 continues to be lower than the threshold value and thus the judgment result is not varied.

In the communication module 30, the transmitter 32 continues to transmit a train of subsequent compressed image data to the communication module 30E (external device 40) through the substitute radio transmission line as indicated by a broken line in FIG. 2 while addressing to the communication module 30E.

[3] When the residual amount of the battery 27 exceeds the threshold value and thus the judgment result is varied.

When the step S3 of FIG. 3 is negatively judged, the communication module 30 judges that the residual amount of the battery 27 is equal to a threshold value or more (step S9 of FIG. 3). In the communication module 30, the transmitter 32 transmits a “residual-amount increase notification” signal to the external device 40 through the substitute radio transmission line described above while addressing to the external device 40 (FIG. 2(10), step S10 of FIG. 3) and also transmission of a subsequent train of compressed image data is temporarily stopped (step S11 of FIG. 3).

In the external device 40, when the “residual-amount increase notification” signal is received (step S103 of FIG. 4), the receiver 34E cooperates with the transmitter 32E through the communication controller 31E. The transmitter 32E transmits the “residual-amount increase response” meaning the above fact to the communication module 30 (imaging device 10) through the up link of the substitute radio transmission line described above while addressing to the communication module 30 (FIG. 2(11), step S104 of FIG. 4). Furthermore, the receiver 34E prepares for forming the MIMO transmission line in place of the substitute radio transmission line between the receiver 34E and the communication module 30 provided to the imaging device 10 (for example, start of supply of drive power associated with all the power amplifiers which are provided to the transmitter 32E and the receiver 34E respectively and used to form the MIMO transmission line, and start of the operation thereof) (FIG. 2(12), step S105 of FIG. 4).

The executing order of the steps S104 and S105 of FIG. 4 may be inverted. In this case, the “residual-amount increase response” becomes a signal representing that the reception preparation for the MIMO transmission is completed. Furthermore, the steps S104 and S105 of FIG. 4 may be executed in parallel.

In the communication module 30, when the receiver 34 receives the “residual-amount increase response” signal transmitted from the external device 40 (step S12 of FIG. 3), it cooperates with the transmitter 32 through the communication controller 31. The receiver 34 prepares for forming up and down links of the MIMO transmission line described above between the receiver 34 and the communication module 30E provided to the external device 40 (for example, containing start of the operation of the all the power amplifiers which are provided to the transmitter 32 and the receiver 34 respectively and used to form the MIMO transmission line and start of supply of drive power thereto) (FIG. 2(13), step S13 of FIG. 3). Furthermore, when the preparation as described above is completed, the transmitter 32 starts the transmission of a subsequent train of compressed image data to the communication module 30E (external device 40) through the MIMO transmission line (FIG. 2(14), step S14 of FIG. 3).

[4] When the residual amount of the battery 27 continues to be higher than the threshold value and thus the judgment result is not varied

In the communication module 30, the transmitter 32 continues to transmit a subsequent train of compressed image data to the communication module 30E (the external device 40) through the MIMO transmission line as represented as a hatched portion in FIG. 2 while addressing to the communication module 30E.

During the period when the train of the compressed image data is addressed and transmitted to the communication module 30E (external device 40) through the above MIMO transmission line, the transmitter 32 divides the train of the compressed image data into plural (it is assumed to [2] which is equal to the total number of the antennas 35-1, 35-2) trains of data, and generates two transmission waves which are modulated in parallel to these data trains. Furthermore, the transmitter 32 transmits these two transmission waves in parallel while addressing from the antennas 35-1 and 35-2 to the external device 40 through the antenna shared unit 33. The MIMO transmission line based on the above spatial division multiplexing method is formed between the antennas 35-1 and 35-2 and the antennas 35E-1, 35E-2 provided to the external device 40.

In the external device 40, the two reception waves received through the antennas 35E-1, 35E-2 are subjected to decoding adapted to the spatial division multiplexing method, the signal judgment and other processing by the receiver 34E, whereby the train of the compressed image data described above is restored. In the external device 40, the train of these restored compressed image data is subjected to predetermined processing (for example, collection, analysis and reuse of the compressed image data) through the communication controller 31E.

As described above, it can be avoided that the MIMO transmission line formed together with the external device 40 is kept although the residual amount of the battery 27 is lower than the threshold value and thus much power is continued to be consumed by the power amplifiers provided to the transmitter 32.

As described above, according to this embodiment, on the basis of the judgment that the residual amount of the battery is smaller than the threshold value, the supply of drive power to some of plural branches and the operation thereof are stopped, so that the number of branches used for transmission or reception is set to decrease. Therefore, radio transmission of desired information with high quality and at high speed can be performed through the MIMO transmission line by even a compact device in which the power which can be supplied by the battery is strictly restricted and the interval of the plural antennas which can be mounted or secured is restricted to about several centimeters, and also the radio transmission line which replaces the MIMO transmission line can be secured. Accordingly, the performance and the added value can be enhanced. Here, the branch described above means the combination of an antenna used for transmission or reception and hardware such as a power amplifier corresponding to an individual antenna or the like, and it corresponds to the “antenna section” described in Claims.

In this embodiment, the battery whose residual amount is monitored may be a battery which is not provided to the imaging device 10 as the transmission end of the compressed image data described above, but the external device 40 as the reception end of the compressed image data. In such a case, the processing described above can be implemented by replacing the communication modules 30, 30E with each other and cooperating with each other.

In the above embodiment, the switching (shift) processing between the original MIMO transmission and the substitute radio transmission replacing this MIMO transmission is carried out on the basis of the residual amount judgment of the battery 27.

The switching (shift) processing between the MIMO transmission and the substitute radio transmission may be executed on the basis of the power which is being consumed from the battery 27. For example, in such a case that it is judged that the power supplied from the battery 27 is larger than predetermined value as when the imaging device 10 drives the optical system 12 for an automatic focusing operation or a zooming operation or drives a camera shake correcting optical system (not shown) for camera shake correction, or when a charging operation provided to a next light emitting operation of the illuminating unit 24 or the like is carried out, the MIMO transmission may be shifted to the substitute radio transmission, and when the power supplied from the battery 27 is smaller than the predetermined value, it may be shifted to the MIMO transmission. Furthermore, when these operations are instructed by the operating unit 22 and the controller 23, the MIMO transmission may be shifted to the substitute transmission. This shift operation may be executed by measuring any of the power consumption, current consumption and the terminal voltage of the battery 27, or executed on the basis of a control signal output to each unit to control the operation in the imaging device 10 by the controller 23.

That is, on the basis of the judgment that the consumed power is larger than a predetermined value, the number of branches used for transmission/reception is set to be smaller than that in the case of MIMO transmission which is originally carried out through the maximum number of branches (hereinafter referred to as “maximum speed MIMO transmission”). Furthermore, in this embodiment, the setting of reducing the number of the branches as described above may be performed when the state that the optical system 12 or the correcting optical system is driven or the charging operation described above is carried out is positively detected by a predetermined sequence or sensor and the residual amount of the battery 27 under this state is smaller than a predetermined threshold value.

The switching (shift) processing between the MIMO transmission and the substitute radio transmission may be carried out on the basis of the information amount of a train of image data as a radio transmission target.

The imaging device 10 is configured so that it can obtain RAW data having a large data capacity and compressed image data which are subjected to compression processing at a desired compression rate in the compression decoding processor 17 as image data to be radio-transmitted. For example, When RAW data having a large data amount are transmitted through the MIMO transmission line, the state that larger power than the battery 27 is consumed is continued for a long time. ON the other hand, even when compressed image data having a high compression rate are transmitted through the MIMO transmission line, the state that the larger power than the battery 27 is consumed is continued for a relatively short time.

That is, if the number of branches used for transmission and reception is set to be smaller in comparison with the maximum speed MIMO transmission on the basis of the judgment that the information amount of the transmission information is larger than a predetermined value, it is advantageous because the probability of the temporal competition between the large power consumption state based on the operation of the imaging device 10 and the power consumption state based on the MIMO transmission is reduced.

Furthermore, for example when it is considered that information such as text data, still image, moving picture, sound or the like is transmitted through the MIMO transmission line, the transmitting operation for the text data, the still image data is finished in a relatively short time. However, in the case of the moving picture, sound, etc., a long time is required for transmission.

Accordingly, the switching (shift) processing between the MIMO transmission and the substitute radio transmission may be carried out in accordance with the continuing time of data transmission, in other words, the type of data to be transmitted.

Furthermore, when the data transmission speed of the radio transmission increases, the power consumption may be increased. The switching (shift) processing between the MIMO transmission and the substitute radio transmission may be executed in accordance with the data transmission speed of the radio transmission.

That is, on the basis of the judgment that the speed of transmission/reception of transmission information which is carried out through the MIMO transmission line is larger than a predetermined value, the number of branches used for transmission and reception is set to be reduced as compared with the maximum speed MIMO transmission.

The switching (shift) processing between the MIMO transmission and the substitute radio transmission may be executed while the above respective shift conditions are independent of one another or by combining some shift conditions.

Furthermore, in this embodiment, although the number of antennas provided to each of the communication modules 30, 30E is set to “2”, in the case that the number thereof is equal to “3” or more, the increase/decrease of the number of branches used for maintenance of the MIMO transmission line as the substitute transmission line may be stepwise carried out on the basis of any one of the shift conditions described above.

That is, in this embodiment, the radio transmission line which is formed without using the spatial division multiplexing method is used as the substitute radio transmission line. However, in place of this radio transmission line, a ratio communication line which is formed on the basis of the number of antennas (the number of branches) provided to each of the communication modules 30, 30E (for example, the antenna number (branch number) smaller than “3” (for example, “2”), for example) may be used, that is, the number of antennas (the number of branches) used for transmission is reduced and one style of the MIMO transmission line which is stepwise maintained in the above plural styles may be used. Even the substitute radio transmission line as described above can implement power saving although transmission characteristics such as transmission speed, etc. are deteriorated as compared with the MIMO transmission line formed through the maximum number of antennas (branches).

Furthermore, in this embodiment, the number of antennas (the number of branches) used for radio transmission may be set to decrease when it is judged that the length of the radio transmission line formed between this device and the external device 40 (communication module 30E) (the distance between the transmission end and the reception end) is shorter than a predetermined value, thereby reducing unnecessary power consumed during the period when transmission quality and transmission speed which are higher than necessary are obtained by the MIMO transmission. The length of the radio transmission line may be input from a range finder provided to the imaging device 10 or manually input by an operator. Furthermore, in this embodiment, the transmission is adjourned prior to the switching operation between the MIMO transmission line and the substitute radio transmission line. However, the transmission efficiency may be kept high in average by performing the cooperation associated with the switching operation between the communication modules 30, 30E, not through the MIMO transmission line, but through the channel (radio transmission line) formed stationarily or at a predetermined period or frequency.

### Second Embodiment

The operation of a second embodiment according to the present invention will be described with reference to FIGS. 1 and 2. The feature of the present invention resides in the following operation which is carried out by the cooperation of the communication controller 31, the transmitter 32 and the battery residual amount detector 26 under the control of the controller 23.

The controller 23 judges the magnitude relation between the residual amount of the battery 27 detected by the battery residual detector 26 and the threshold value described above (FIG. 2(2)), and during the period when the residual amount of the battery 27 is lower than a threshold value for judging the residual amount of the battery 27 shown in the first embodiment, the controller 23 notifies the residual amount of the battery 27 to the communication controller 31 (FIG. 2(3)). The communication controller 31 outputs the thus-notified residual amount to the transmitter 32 together with the above judgment (FIG. 2(4)). As the residual amount is smaller, the transmitter 32 reduces the power supply voltage of the power amplifier in the transmitter 32, or sets the amplification factor of the power amplifier to a small value, whereby the transmission power applied at the time of transmission to the substitute radio transmission line is set to a small value (FIG. 2(a)). That is, during the period when it is judged that the residual amount of the battery 27 is smaller than the threshold value, the transmission power is set to a small value in connection with the decrease of the residual amount. Accordingly, when the length of the propagation line of the substitute radio transmission line and the propagation loss are large to the permissible extent, the actuation time of the imaging device 10 is lengthened by the residual amount of the battery 27.

The control of the transmission power shown in the second embodiment is carried out for power saving in accordance with the results of not only the residual amount of the battery, but also the judgment of power to be consumed as described above, the judgment of the information amount to be transmitted, the judgment of the transmission/reception speed or the judgment of the distance between the reception and transmission ends.

In the above embodiments, the train of compressed image data are wirelessly transmitted through the MIMO transmission line or the substitute radio transmission line formed between the imaging device 10 (the communication module 30) as the transmission end and the external device 40 (the communication module 30E) as the reception end. However, when the transmission end and the reception end are inverted to each other, for example, the processing to be subjected to the image information received by the receiver 34 and the other transmission information may be a display through the monitor 19, the data format based on the data format converter 20 or any other processing. Furthermore, in the above embodiments, when the power consumption is different between the transmitter 32 (32E) and the receiver 34 (34E), the threshold values at the transmission time and at the reception time may be made different from each other. For example, when the power consumption of the transmitter at the transmission time is larger than the power consumption of the receiver at the reception time, the threshold value for the comparison of the residual amount of the battery at the transmission time is set to a larger value than the threshold value for the comparison of the battery residual amount at the reception time. In the above embodiments, the communication module 30 may be configured as a package which is detachably configured through a desired connector as in the case of a “PC card” conformed with the standards of PCMCIA (Personal Computer Memory Card International Association). Furthermore, the communication module 30 may be installed or mounted in a cellular phone terminal which functions while connected to an imaging device having no communication module 30.

Furthermore, all or some of the constituent elements of the communication modules 30, 30E may be configured as a single integrated circuit. Furthermore, in the above embodiments, the substitute radio transmission line may be formed as any one of a radio transmission line which can implement both or any one of a reception diversity and a transmission diversity by using both the antennas 35E-1, 35E-2 and different from the MIMO transmission line based on the spatial divisional multiplexing method, and a different MIMO transmission line which can be formed even when the number of antennas being used is changed (one style of MIMO transmission line which is stepwise kept at plural styles by reducing the number of the above antennas). Furthermore, in the above embodiments, the residual amount of the battery 27 is detected at a predetermined period or frequency by the controller 23. However, such a residual amount may be successively detected at the time point when the comparison with the lower limit value or the threshold value as described above should be carried out.

Furthermore, in the above embodiments, the modulation/demodulation system, the frequency arrangement, the channel construction and the multi-access system which are applied to the radio transmission through the MIMO transmission line or the substitute radio transmission line may be any ones. Still furthermore, in the above embodiments, the imaging device 10 and the external device 40 are not limited to the device or equipment having the function described above, and for example, it may be PDA (Personal Digital Assistance) which is accommodated in a small housing and supplied with drive power by a battery, and also to which high quality or high speed radio transmission based on MIMO transmission is required to be implemented or any other equipment. Furthermore, in the above embodiments, the supply source for the drive power is not limited to a mere primary battery or secondary battery, and it may be a battery which can supply any energy source accumulated in advance as power or a power source whose maximum supply power is restricted, such as AC adaptor or the like.

Still furthermore, in the above embodiments, when the number of branches used for transmission and reception increases or decreases in accordance with the magnitude relation between the residual amount of the battery 27 and the threshold value, both or one of the imaging device 10 (the communication module 30) and the external device 40 (the communication module 30E) may be provided with a function of notifying the above fact to an operator as sound information or display information, thereby enhancing the added value and convenience.

Furthermore, in the above embodiments, even under the state that the residual amount of the battery 27 continues to decrease with being less than the threshold value, the “substitute radio transmission line” using no spatial division multiplexing method is kept between the imaging device 10 (communication module 30) and the external device 40 (communication module 30E). However, this invention is not limited to this construction, and under the state that the residual amount of the battery 27 is not more than a lower limit value smaller than the threshold value descried above, the number of branches used for radio transmission between the imaging device 10 (communication module 30) and the external device 40 (communication module 30E) is set to “0”, and the radio transmission is substantially restricted, whereby power necessary for the minimum limited operation (the operation of an installed calendar, a non-volatile memory or the like) of the imaging device 10 and the external device 40 may be secured.

Still furthermore, in the above embodiments, the battery 27 may be charged with power supplied from a commercial power source by an AC adaptor or the like. During the period when the battery 27 is charged by the AC adaptor or the like as described above, the increase/decrease of the number of branches based on the comparison result between the threshold value described above and the lower limit value is omitted, and for example, the MIMO transmission may be carried out through the maximum number of branches.

Still furthermore, in the above embodiments, the gain of the diversity of the radio transmission between the imaging device 10 (communication module 30) and the external device 40 (communication module 30E) is secured on the basis of the spatial division multiplexing method under the state that the number of antennas allowed to be used for the radio transmission concerned is plural even when the number of antennas provided to each of the communication modules 30, 30E is equal to “3” or more.

However, the diversity gain as described above may be secured by any of a spatial diversity (power feed and terminal targets out of plural antennas which are displaced from one another by several wavelengths are determined by selection or combination), a polarized wave diversity (power feed and terminal targets out of plural antennas which are different in polarized wave plane from one another are determined by selection or combination), a frequency diversity (plural antennas are used for radio transmissions of different frequency bands which have low phasing correlation with each other, and power feeding and terminal targets out of these plural antennas are determined by selection or combination), and a time diversity (common antennas are redundantly used as power feed or combination targets during different periods of low phasing correlation with each other).

Furthermore, the present invention is not limited to the above embodiment, and embodiments having various constructions may be implemented, and any improvement may be made to all or some of the constituent devices.

1-14. (canceled)

15. A radio device comprising:
a plurality of antenna sections performing radio communication on an MIMO transmission line by a spatial division multiplexing method; and
a controller which decreases the number of said antenna sections used for said radio communication when residual amount of a power supply unit supplying power to said antenna sections is smaller than a predetermined first value and a predetermined unit in the radio device is instructed to be driven.

16. The radio device according to claim 15, wherein
said power supply unit switches power supplied from a battery and power supplied from a commercial power source to each other and supplies the power to said antenna sections; and
said controller does not decrease the number of said antenna sections even when the voltage from said battery decreases.

17. The radio device according to claim 15, wherein
said antenna sections comprise plural antennas which transmit and receive electrical waves and an electrical circuit connected to said antennas.

18. The radio device according to claim 15, wherein
said controller decreases the number of said antenna sections used for the radio communication when the residual amount of said power source is smaller than a predetermined second value.

19. The radio device according to claim 15, wherein
said controller controls to perform substitute radio transmission based on a non-spatial division multiplexing method on a radio transmission line formed by said antenna sections when the number of said antenna sections is decreased by one.

20. The radio device according to claim 15, wherein
said controller controls to perform substitute ratio transmission based on a non-spatial division multiplexing method on a radio transmission line formed by said antenna sections and also carry out a diversity operation when the number of said antenna sections is decreased to a number smaller than a predetermined third value.

21. The radio device according to claim 15, wherein
said controller controls to perform substitute ratio transmission based on a spatial division multiplexing method corresponding to the number of said antenna sections used for the radio communication on a radio transmission line formed by said antenna sections used for said radio communication when the number of said antenna sections is reduced to a number smaller than a predetermined fourth value.

22. The radio device according to claim 15, wherein
said controller reduces an amplification degree in the electrical circuit of said antenna section used for the spatial dividing multiplexing method when the residual amount of said power source is smaller than a predetermined seventh value.

23. The radio device according to claim 15, wherein
said controller notifies change of the number of said antenna sections to one of a reception terminal and transmission terminal of said MIMO transmission line before the number of said antenna sections used for said radio communication is changed.

24. An electronic device comprising
the radio device according to claim 15, and
a reception information processor processing information received by said radio device.

25. The electronic device comprising
the radio device according to claim 15, and
a transmission information processing unit which processes information to be transmitted by said radio device.

26. An imaging device comprising
an imaging element which picks up an image of a subject, and
the radio device according to claim 15.

27. The imaging device according to claim 26, further comprising
an imaging optical system forming an image of a subject on said imaging element, wherein
driving of said predetermined unit is driving of said imaging optical system.

28. The radio device according to claim 15, wherein
driving of said predetermined unit is charging operation from said power supply unit to said predetermined unit.

29. A radio device comprising:
a plurality of antenna sections performing radio communication on an MIMO transmission line by a spatial division multiplexing method; and
a controller which decreases the number of said antenna sections used for said radio communication due to reduction of a voltage supplied from a power supply unit supplying power to said antenna sections, wherein
said controller sets maximum number of said antenna sections when power is supplied from a commercial power source to said antenna sections.
